(19) United States
(12) Patent Application Publication
(10) Pub. No.: US 2012/0232951 A1
(43) Pub. Date: Sep. 13, 2012

(54) SENDING PRODUCT INFORMATION BASED ON DETERMINED PREFERENCE VALUES

(75) Inventors: Ningjun Su, Hangzhou (CN); Xu Zhang, Hangzhou (CN); Rongshen Long, Hangzhou (CN); Zhixiong Yang, Hangzhou (CN)

(73) Assignee: ALIBABA GROUP HOLDING LIMITED, George Town (KY)

(21) Appl. No.: 13/406,240

(22) Filed: Feb. 27, 2012

(30) Foreign Application Priority Data
Mar. 8, 2011 (CN) 201110056046.1

(51) Int. Cl. G06Q 30/02

(52) U.S. Cl. 705/7.29

(57) ABSTRACT

Determining which product information to send to a user based on a determined preference value is disclosed, including: determining pieces of user action data that are associated with a current information collection period, the user, and the product category; determining a new visit quantity associated with the current information collection period; determining an updated cumulative visit quantity associated with the product category based at least in part on the new visit quantity associated with the current information collection period; determining a total duration value associated with the product category based at least in part on a duration value associated with the current information collection period; determining a visit interval value associated with the product category and the current information collection period; and determining a long-term preference value associated with the user for the product category.

### CROSS REFERENCE TO OTHER APPLICATIONS

This application claims priority to People's Republic of China Patent Application No. 201110056046.1 entitled A METHOD AND DEVICE FOR COLLECTING AND SENDING USER BEHAVIOR INFORMATION filed Mar. 8, 2011 which is incorporated herein by reference for all purposes.

### FIELD OF THE INVENTION

The present application relates to the information technology field. In particular, it relates to sending product information to a user.

### BACKGROUND OF THE INVENTION

Typically, a server pushes information (e.g., product information, advertisements and/or promotions) at a rate and/or manner as determined by the user's actions (e.g., the categories of webpages that the user had browsed, the products that the user had searched for) over a relatively short period of time with respect to a website related to the server. For example, this period of time can be one month.

User actions are typically stored in databases. Typically, a database only has enough storage to store user actions associated with a short period of time and is reset after each period has ended. Furthermore, when the database has not stored user action data for a period of time, the server is unable to determine the interests of the user. Sometimes, when there is no stored user actions for a user, the server will determine that the user is a new user and push information to the user associated with the type of information that is intended to be sent to new users, which may not be desirable to a user who has actually visited the website associated with the server before. For example, the user could only visit the website every once in a while and as a result, the database could include no user action data for the user since any previous data associated with the user in the database may have already been deleted. As a result, the server is unable to determine the user's interests accurately, which in turn affects the accuracy of the information pushed to the user. If the time period over which user action data is collected at the database is increased, then the accuracy associated with user interests could be improved somewhat, but such an increase will demand an increase of storage space and thus expenses.

As such, it is difficult to track user interests/actions over a long period because it would be costly to do so but a lack of tracked user interest/actions could detrimentally affect the accuracy of the product information that is pushed out to the users.

### BRIEF DESCRIPTION OF THE DRAWINGS

Various embodiments of the invention are disclosed in the following detailed description and the accompanying drawings.

FIG. 1 is a diagram showing an embodiment of a system for collecting user action data from one or more clients.

FIG. 2 is a flow diagram showing an embodiment for determining a user's long-term preference value for a product category.

FIG. 3 is an example table in which user and preference values may be stored.

FIG. 4 is a flow diagram showing a process of sending product information to users based on a user's preference value for a product category.

FIG. 5 is a diagram showing an embodiment of a system for determining preference values.

FIG. 6 is a diagram showing an embodiment of a system for sending product information to users based on associated preference values.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Determining a user's long-term preference values for product information associated with various product categories while saving storage space is disclosed. As used herein, a “long-term preference value” is associated with a product category and refers to how much interest a user has in that product category over a relatively long period of time. For example, a relatively long period of time can be a series of information collection periods. As will be discussed below, a user's long-term preference value associated with a product category is determined based at least in part on the rate that the user interacts with webpages associated with that product category over a plurality of information collection periods.

In some embodiments, in addition or alternative to determining long-term preference values associated with product categories, short-term preference values and/or current preference values associated with product categories can be determined.

In various embodiments, the determined long-term preference values, short-term preference values, and/or current preference values associated with product categories for a user are used to determine the type, rate, volume, and/or manner of product information to be pushed out to the user. In some embodiments, the type, rate, volume, and/or manner of product information to be pushed to a user for a product category is determined based on rules for each type of preference value (e.g., long-term, short-term, and current) associated with that product category.

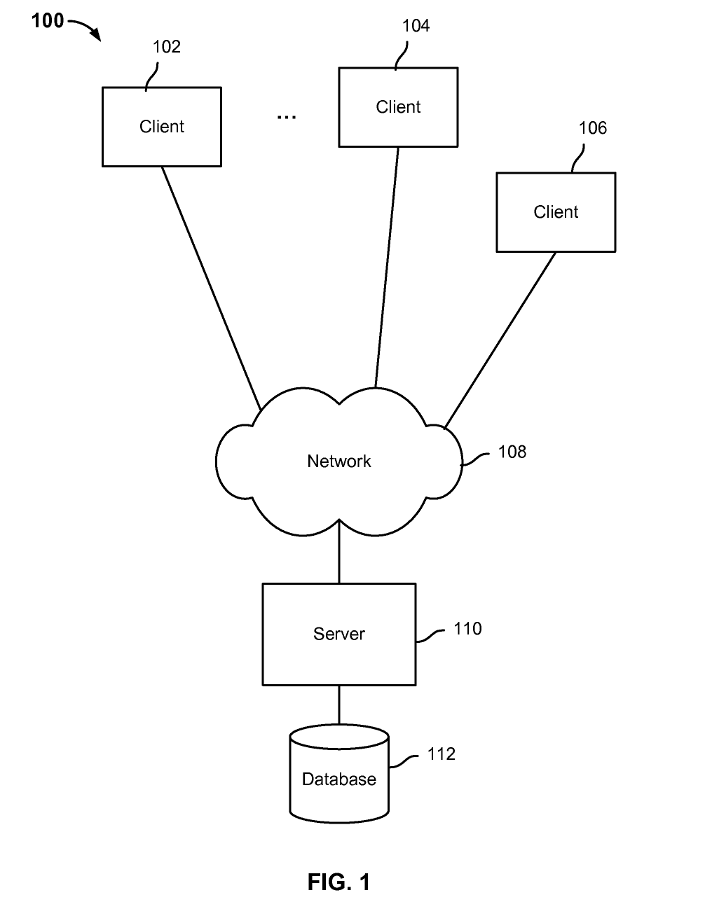

FIG. 1 is a diagram showing an embodiment of a system for collecting user action data from one or more clients. System 100 includes clients 102, 104, 106, network 108, server 110, and database 112. Network 108 includes high-speed data and/or telecommunications networks.

Server 110 is configured to collect user action data stored for each user at clients 102, 104, and 106. While three clients are shown in system 100, system 100 is configured to collect user action data from more or fewer clients. Each of clients 102, 104, and 106 can be a laptop computer, a desktop computer, a tablet, a mobile device, a smart phone, or any other computing device. In some embodiments, a web browser application is installed at each client and enables a user to access webpages associated with a website hosted by server 110. In some embodiments, the website hosted by server 110 is an e-commerce website. Server 110 may comprise a single or multiple devices.

User actions associated with a product category (e.g., sports equipment) of an e-commerce website can include any interactions by the user with respect to a webpage (e.g., a webpage of a product) associated with that product category. Examples of types of user actions include: search actions, browse actions, click actions, submission of feedback actions, and purchase transaction actions. For example, if a user purchases a tennis racquet at the e-commerce website, then that can be referred to as a purchase transaction action associated with the product category of sports equipment.

In some embodiments, a client (e.g., 102, 104, and 106) is configured to store each user action as data associated with the type associated with the user action, an identifier associated with the user that performed the user action, an identifier associated with the product category associated with the user action, a timestamp at which the user action was performed, and any other relevant data. Clients send the stored user action to the server. In some embodiments, a client may send to the server each piece of stored user action data soon after it is recorded, send several pieces of stored user action data every preset period, or send pieces of stored user action data in response to a designated event. In response to receiving user action data sent from clients, server 110 is configured to generate a log based on the user information that records the type associated with the user action, an identifier associated with the user that performed the user action, an identifier associated with the product category associated with the user action, a timestamp at which the user action was performed, and any other relevant data for each received piece of user action data. In some embodiments, the log is stored at database 112, which is accessible by server 110.

In some embodiments, a current information collection date is configured by a system administer. As used herein, an information collection period is defined by two dates; the starting date and the ending date. As used herein, the current information collection period is defined by a current information collection date (e.g., the most recently configured information collection date) and the previous information collection date (e.g., the information collection date immediately prior to the current information collection date). The date of the previous information collection is stored at the server 110 and/or database 112 so that it can be recalled to determine a current information collection period. For example, if the current information collection date is Apr. 21, 2010, and the previous information collection date was Mar. 20, 2010, then the current information collection period is Mar. 20, 2010 through Apr. 21, 2010. Once the user action data associated with a current information collection period is analyzed and the long-term preference values associated with product categories (and other values as described below) are determined, the user action data associated with the current information collection period is discarded/deleted from database 112 so that there will be storage space available for subsequent user action data submitted by clients. In various embodiments, user action data associated with previous information collection periods is not maintained in database 112 but instead, certain values that represent the cumulative determined user action data statistics from previous information collection periods are stored at database 112. Because these values need fewer resources to maintain than several information collection periods' worth of user action data, the storage space of the database is optimized for the reception of new user action data.

In various embodiments, each new/most recent information collection date is referred to as the current information collection date and the information collection date that was the one immediately prior to the new/most recent information collection date is referred to as the previous information collection date. When a subsequent information collection date is configured, the existing current information collection date becomes the previous information collection date, and the subsequent information collection date becomes the current information collection date. Thus, analysis of long-term preference values for information collection periods is iterative and repeats for each newly defined current information collection period.

To determine the user action data that is associated with a current information collection period, server 110 is configured to search through database 112 for stored user action data associated with timestamps that are in between the date on which the previous information collection occurred and the date on which the current information collection occurred. Once the user action data associated with a current information collection period is determined, it can be analyzed to determine long-term preference values of users for various product categories.

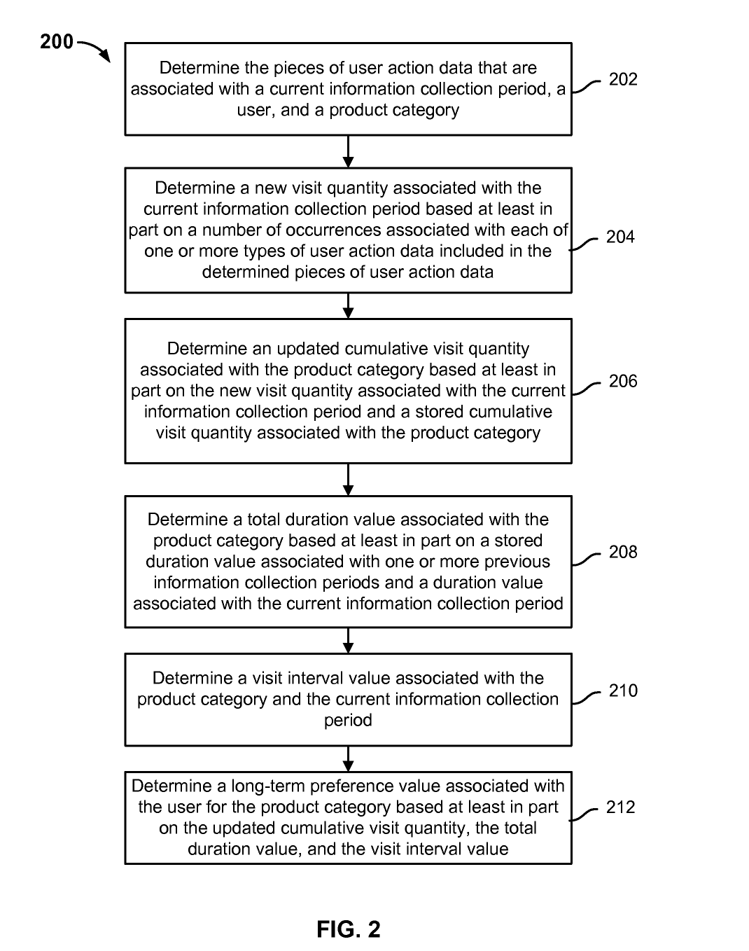

FIG. 2 is a flow diagram showing an embodiment for determining a user's long-term preference value for a product category. In some embodiments, process 200 is implemented on system 100.

Process 200 is determined for one user with respect to one product category. However, process 200 may be repeated for the same user with respect to one or more other product categories. Process 200 can also be repeated for other users.

At 202, pieces of user action data associated with a current information collection period, a user, and a product category are determined.

In some embodiments, the current information collection period is determined based on the stored date of the previous information collection and the date of the current information collection.

For example, if the last information collection date was on Jan. 1, 2011, and the date of the current information collection is on Jan. 31, 2011, then the information collection time period is determined to be from Jan. 1, 2011 to Jan. 31, 2011.

After the current information collection period is determined, the log is searched for the pieces of user action data with timestamps associated with the current information collection period. The matching pieces of user action are then obtained.

In some embodiments, the obtained pieces of user action data are automatically examined to determine the subset of user action data that is associated with the particular user for which process 200 is performed. Then, the subset of pieces of user action associated with the user is automatically examined to determine a further subset that is associated with the product category for which process 200 is performed.

At 204, a new visit quantity associated with the current information collection period is determined based at least in part on a number of occurrences associated with each of one or more types of user action data included in the determined pieces of user action data.

In some embodiments, the new visit quantity is a quantity that represents the number of occurrences of one or more types of user actions obtained for the particular user and the particular product category associated with the current information collection period. Determining the new visit quantity associated with the current information collection period includes determining the number of occurrences of each type of user action included in the obtained pieces of user action data. As mentioned above, examples of types of user actions include search actions, browse actions, click actions, submission of feedback actions, and purchase transaction actions. The obtained pieces of user action data are then analyzed and a number of occurrences associated with each type of user action is determined from the obtained pieces of user action data.

For example, assume that the new visit quantity is being performed for User A with respect to Product Category B. Once the pieces of user action data associated with User A and Product Category B are obtained from the log, a server such as server 110 is configured to count the number of occurrences of each type of user action (e.g., search action, browse action, click action, submission of feedback action, and purchase transaction action) present among the obtained pieces of data. For example, the counted number of occurrences of each type of user action data can be stored in a variable associated with that type of user action (e.g., x₁, x₂, . . . , xₙ, where x₁ is associated with the number of occurrences of one type of user action, x₂ is associated with the number of occurrences of a second type of user action, . . . , and xₙ is associated with the number of occurrences of the nth type of user action).

After determining the number of occurrences of each type of user action from within the obtained pieces of user action data, the new visit quantity associated with the current information collection period can be determined based on such numbers of occurrences. In some embodiments, the new visit quantity associated with the current information collection period can be determined by a sum of all the numbers of occurrences associated with the different types of user actions. In some embodiments, the new visit quantity associated with the current information collection period can be determined by attributing a weight to each of the numbers of occurrences associated with the different types of user actions and then adding together all the weighted numbers of occurrences. For example, a weight attributed to the number of occurrences of a particular type of user action can be a greater value if the type of user action is associated with voluntary submission of information by the user (e.g., search action type, click action type, and purchase transaction type). For example, the new visit quantity associated with the current information collection period can be represented by the following formula:

Y=w₁x₁+w₂x₂+ . . . wₙxₙ

where Y represents the new visit quantity associated with the current information collection period and wₙ represents the weight assigned to the number of occurrences associated with the nth type of user action and x₁, represents the number of occurrences associated with the nth type of user action.

At 206, an updated cumulative visit quantity associated with the product category is determined based at least in part on the new visit quantity associated with the current information collection period and a stored cumulative visit quantity associated with the product category.

An updated cumulative visit quantity refers to the visit quantity for the user with respect to the product category accrued from previous information collection period(s) (“stored cumulative visit quantity”) and from the current information collection period (the “new visit quantity”). The stored cumulative visit quantity is associated with the accrued visit quantities of all previous information collection periods since the user's first interaction with a webpage associated with the product category. As mentioned above, the new visit quantity is associated with the current information collection period. Therefore, the updated cumulative visit quantity is a combination (e.g., sum) of the stored cumulative visit quantity and the new visit quantity.

Furthermore, once the analysis of the long-term preference value is completed for the current information collection period, the used user action data associated with the current information collection period is deleted and the updated cumulative visit quantity becomes the new stored cumulative visit quantity as a subsequent information collection period begins. That way, the new stored cumulative visit quantity can be used in the next determination of the long-term preference value for the user for the product category for the subsequent information collection period.

In some embodiments, the stored cumulative visit quantity associated with the user with respect to the product category is stored at the server, a database accessible by the server and/or other network equipment. In some embodiments, the server, a database accessible by the server and/or other network equipment can also be used to store the stored cumulative visit quantities associated with the same user and various other product categories and/or other users with respect to different product categories.

At 208, a total duration value associated with the product category is determined based at least in part on a stored duration value associated with one or more previous information collection periods and a duration value associated with the current information collection period.

A total duration value associated with the product category and associated with the current information collection period (which again, is defined as the period between the previous information collection date and the current information collection date) refers to the length of time between the user's first interaction with a webpage of the e-commerce website associated with the product category and the date associated with the current information collection. A stored duration value associated with one or more previous information collection periods refers to the length of time between the user's first user action associated with a webpage of the e-commerce website up until the date of the previous information collection. So, the total duration value is a combination of the stored duration value associated with one or more previous information collection periods and a duration value associated with the current information collection period (i.e., the length of time between the previous information collection and the current information collection). In various embodiments, the total duration value, the stored duration value, and the duration value associated with the current information collection period comprises days (i.e., each duration value is an integer value that represents a number of days). Furthermore, each duration value (e.g., the total duration value, the stored duration value, the duration value associated with the current information collection period) is incremented by one for each day regardless of how many, if any, user actions are performed with respect to a webpage associated with the product category that day.

For example, assume that the date of User A's first interaction with a webpage associated with a Product Category B was on Mar. 21, 2010. Assume that the current collection date is on Apr. 21, 2010 and the previous collection date was Mar. 20, 2010. The information collection time period is therefore Mar. 21, 2010 through Apr. 21, 2010. Since the user did not visit Product Category B prior to the start of the current information collection period (i.e., the date of the previous information collection), the saved stored cumulative visit quantity (the accrued visit quantities of all previous information collection periods since User A's first user action associated with a webpage of Product Category B) for Product Category B is 0. The number of visits (the new visit quantity) associated with Product Category B that User A had performed during the current information collection period between Mar. 21, 2010 through Apr. 21, 2010 can be determined from the relevant pieces of user action data (i.e., user action data associated with User A and Product Category B that took place between Mar. 21, 2010 through Apr. 21, 2010) obtained from a log stored at a database. In the example, the new visit quantity associated with the current information collection period is 20. Since the updated cumulative visit quantity for User A with respect to Product Category is the combination of the stored cumulative visit quantity and the new visit quantity associated with the current information collection period and in this example, the value of the stored cumulative visit quantity is 0, then the updated cumulative visit quantity is simply the value of the new visit quantity, which is 20. Since the total duration value is the combination of the stored duration value and the duration value associated with the current information collection period and in this example, the stored duration value is zero (because there were no previous information collection periods), the total duration value is simply the duration of the current information collection period, which is 31 days. To summarize, for the current information collection period between Mar. 21, 2010 through Apr. 21, 2010, the updated cumulative visit quantity of 20 and the total duration value of 31 are stored. However, to save storage space, the user action data used for the Mar. 21, 2010 through Apr. 21, 2010 collection period is deleted in preparation for the subsequent information collection period.

Assume that the subsequent information collection time is on May 21, 2010, which then becomes the new current information collection date. This new current information collection period is then defined by the time between the previous information collection date of Apr. 21, 2010 and the current information collection date of May 21, 2010. The information collection period between Mar. 21, 2010 through Apr. 21, 2010 is now referred to as the previous information collection period and the updated cumulative visit quantity of 20 is now stored as the stored visit quantity and the total duration value of 31 is now stored as the stored duration value for this new current information collection period. The number of visits (the new visit quantity) associated with Product Category B that User A had performed during the current information collection period between Apr. 21, 2010 to May 21, 2010 can be determined from the relevant pieces of user action data (i.e., user action data associated with User A and Product Category B that took place between Apr. 21, 2010 to May 21, 2010) obtained from a log stored at a database. In the example, the new visit quantity associated with the current information collection period is 25. The updated cumulative visit quantity is the combination of the stored cumulative visit quantity, 20, and the new visit quantity associated with the current information collection period, 25. So, the updated cumulative visit quantity associated with the current information collection period between Apr. 21, 2010 and May 21, 2010 is 25+20=45. The total duration value is the combination of a stored duration value, 31, and the duration value associated with the current information collection period, 30. So, the total duration value associated with the current information collection period between Apr. 21, 2010 and May 21, 2010 is 31+30=61. Once the updated cumulative visit quantity of 45 and the total duration value of 61 are determined and stored for the information collection period between Apr. 21, 2010 and May 21, 2010, the user action data used can be deleted to make room for user action data associated with subsequent information collection periods. Subsequent collection information dates can be determined and processes similar to those described above can be repeated.

At 210, a visit interval value associated with the product category and the current information collection period is determined.

The visit interval value is the difference between the date of the user's most recent user action associated with the product category and the date of the current information collection. In some embodiments, if the date of the user's most recent user action associated with the product category occurred within the range of the current information collection period, then the visit interval value is determined based on counting the days in between the date of the user's most recent user action associated with the product category and the date of the current information collection.

In some embodiments, if the user's most recent user action associated with the product category occurred before the beginning of the current information collection period, then the visit interval value can be determined based on a stored visit interval value associated with the user and the product category and the date of the current information collection. Because the user's most recent user action associated with the product category is not within the current information collection period, the visit interval value cannot be determined as simply the difference between the date of the user's most recent user action associated with the product category and the date of the current information collection. The stored previous visit interval value was stored for the previous information collection period and is the difference between the date of the user's most recent user action associated with the product category and the date of the previous information collection. Thus, the visit interval value associated with the product category and the current information collection period can be determined by adding the duration value associated with the current information collection period (the number of days between the previous information collection date and the current information collection date) to the stored visit interval value.

For example, assume that the current information collection period is defined as being from Jan. 1, 2011 to Jan. 30, 2011, and if the user's most recent user action associated with the product category is not within the current information collection period, then it can be determined that the time of the user's most recent user action associated with the product category took place at a date prior to Jan. 1, 2011. Therefore, a stored visit interval value for the user and the product category can be retrieved and used. This stored interval value can be the difference between the date of the user's most recent user action associated with the product category and the date of the previous information collection. Therefore, the visit interval value for the current information collection of the user for the product category is the sum of the stored visit interval value and the duration value associated with the current information collection period.

At 212, a long-term preference value associated with the user for the product category is determined based at least in part on the updated cumulative visit quantity, the total duration value, and the visit interval value.

In some embodiments, the long-term preference value associated with the user for the product category is determined as the product of the updated cumulative visit quantity and the total duration value divided by the visit interval value. An example formula for the long-term preference value associated with the user for the product category can be expressed as:

$$P = \frac{( Y * F )}{T}$$

where P represents the long-term preference value associated with the user for the product category, Y represents the updated cumulative visit quantity of the user for this product category, F represents the total duration value, and T represents the visit interval value of the user for this product category.

The determined long-term preference value associated with each user for each of one or more product categories (as determined using a process such as process 200) can be stored.

In some embodiments, because there could be many users and each could be associated with several long-term preference values corresponding to various product categories, the amount of user long-term preference data can be great and thus, use a lot of storage resources. So in order to save storage resources, some user long-term preference data can be not stored. In some embodiments, a long-term preference value threshold value is set for each product category such that data associated with users' long-term preference values associated with that product category that are less than the threshold are not stored and only those user long-term preference values that meet or exceed the threshold are stored.

In some other embodiments, a long-term preference threshold is set for each user such that the long-term preference values associated with that user that are below the threshold are not stored and only those long-term preference values of the user that meet or exceed the threshold are stored.

A process such as process 200 enables saving storage space by storing only certain values that can be used to represent the information within a certain information collection period and also be used to determine the long-term preference value of a product category for a particular user for a subsequent current information collection period in place of permanently storing the underlying user action data of a previous information collection period. These certain values include the stored cumulative visit quantity, the stored duration value, the stored visit interval value, and the date of the previous information collection. In various embodiments, to determine the user long-term preference value for a product category for a current information collection period, the user action data associated with the current information collection period, and such stored values such as the stored cumulative visit quantity, the stored duration value, the stored visit interval value, and the date of the previous information collection can be used (in lieu of user action data associated with previous information collection periods).

In some embodiments, a short-term preference value of a user for each of one or more product categories can be determined in addition or as an alternative to the user's long-term preference value for each of one or more product categories. The generated short-term preference values are stored. Generally, a user's short-term preference value for a product category is determined based over a user's number of occurrences of user actions associated with the product category each day over a set of several consecutive days (a set of days is shorter than an information collection period that is used to determine the long-term preference value). Also, the set of days generally take place prior to the date of the current information collection. The short-term preference value for a product category reflects the user's shorter-term user action habits with respect to various product categories.

For example, the following is a technique for determining a user's short-term preference value: a user's number of occurrences of user actions with respect to a particular product category is determined (e.g., based on stored user action data) for each day of the set of consecutive days over the short-term preference value. In this example, Y represents the number of occurrences of user actions of all types for day i. In this example, the user's short-term preference value for a product category is based on a model for decay over time. One example model is

$$( t ) = {K}_{1} + exp \{ \frac{t - {K}_{2}}{K 3} \} ,$$

where t is a negative number corresponding to a day in the set of consecutive days (i.e., if it were day 5 in the set of consecutive days then t would be −5), and K₁, K₂, and K₃ are numerical values chosen by the system administrator. So, the user's short-term preference value for a product category over a set of N consecutive days can be determined by:

P(0)Y₀+P(1)Y₁+P(2)Y₂ . . . +P(N)Y_{N}.

In some embodiments, a current preference value of a user for each of one or more product categories can be determined in addition to or as an alternative to the user's long-term preference value and/or short-term preference value for each of one or more product categories. A user's current preference value for a product category reflects an even more transitory interest/user action habits than those reflected by the short-term preference value. In some embodiments, the user's current preference value for a product category can be determined based on user action data that has not yet been accounted for in a long-term preference value analysis. Such user action data can either still be stored at the client (e.g., in local cookie or Flash files) or recently sent to the server but not yet stored in the log, for example. A user's current preference value for a product category can be determined using a known technique. The determined current preference values for product categories for one or more users can be stored.

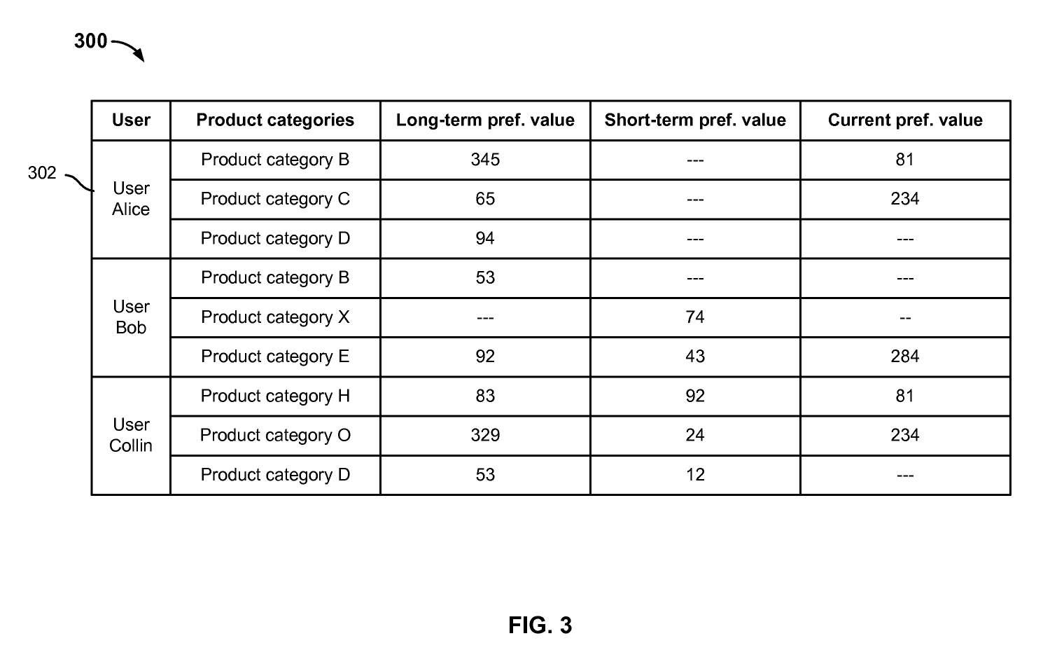

FIG. 3 is an example table in which user and preference values may be stored. In the example, preference value entries (e.g., long-term preference values, short-term preference values, and current preference values) determined for product categories are associated with each user. For example, in the records associated with User Alice in 302, for Product Category B; there are determined long-term preference value (345) and current preference value (81), but not any short-term preference value (if a preference value is not determined for a product category associated with a user, it is indicated as “---” in the example); for Product Category C, there are determined long-term preference value (65) and current preference value (234), but not any short-term preference value; for Product Category D, there is a determined long-term preference value (94) but not any current preference and short-term preference values. As shown in the example, for a product category, not necessarily all three of a long-term preference value, short-term preference value, and current preference value are determined for a product category of a user.

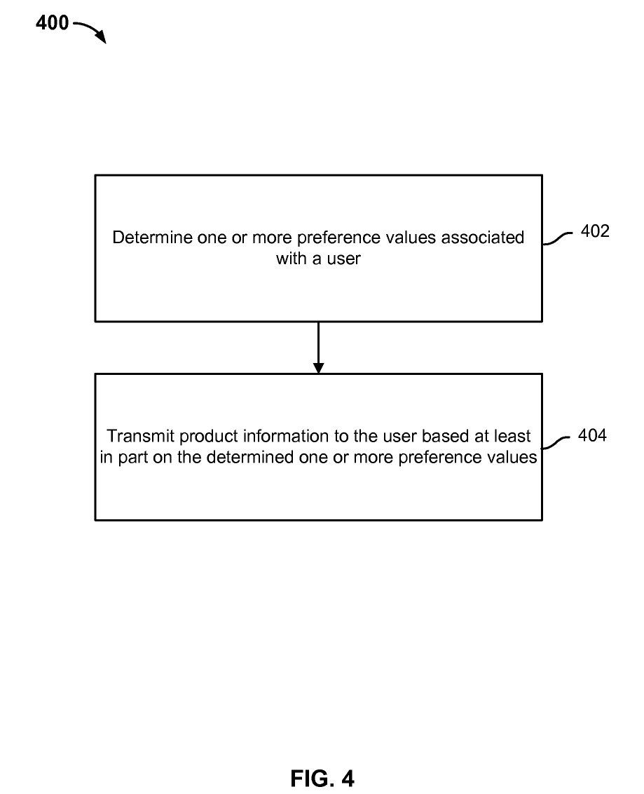

FIG. 4 is a flow diagram showing a process of sending product information to users based on a user's preference value for a product category. In some embodiments, process 400 is performed at system 100.

At 402, one or more preference values associated with a user are determined.

From storage, the one or more preference values associated with a particular user can be determined. The one or more preference values include long-term preference values, short-term preference values, and/or current preference values. Also, the one or more preference values can each be associated with a product category.

At 404, product information is transmitted to the user based on the determined one or more preference values.

For the user, product information associated with one or more product categories is transmitted to the user at one or more manners (e.g., quantities, means, rate) depending on the determined one or more preference values associated with product categories. Product information associated with a product category can include promotional information, advertisements, offers for new products, etc. For example, product information for the product category of sports equipment can include discounts on a certain brand of tennis racquets and an advertisement of a new model of snowboards.

Below are some examples of how which product information to transmit to the user based on the user's one or more preference values is determined:

Generally, for each preference value, whether it is a long-term preference value, a short-term preference value, or a current preference value, the greater the magnitude of the preference value, the greater the likelihood that product information associated with that preference value will be transmitted to the user.

In some embodiments, one or more rules are configured for the, for example, manner, rate, type, and volume of product information that is transmitted for the users to which each of a long-term preference value, short-term preference value, and/or a current preference value is selected for transmitting product information. For example, if User A is associated with a long-term preference value for Product Category B that is selected for sending product information to the associated user, then the configured rules associated with long-term preference values can determine that a recurring weekly digest of the latest promotions, advertisements, and coupons associated with the products of Product Category B is sent to User A. If User A is associated with a short-term preference value for Product Category B that is selected for sending product information to the associated user, then the configured rules associated with short-term preference values can determine that a recurring daily digest of the latest promotions, advertisements, and coupons associated with the products of Product Category B is sent to User A. If User A is associated with a current preference value for Product Category B that is selected for sending product information to the associated user, then the configured rules associated with current preference values can determine that every new promotion, advertisement, and coupon associated with the products of Product Category B is immediately sent to User A as soon as it becomes available.

If there are stored long-term preference, short-term preference, and current preference values for a user for each product category, then the product information to be sent to the user can be based on a quantity of product information associated with the product categories for which there are long-term preference values, a quantity of product information associated with the product categories for which there are short-term preference values, and a quantity of product information associated with the product categories for which there are current preference values. Thus, for each product category, the associated long-term preference values are ranked from the greatest to the lowest in magnitude and the top N1 number of users associated with those highest ranked long-term preference values are sent product information from that product category. Also, for each product category, the associated short-term preference values are ranked from the greatest to the lowest in magnitude and the top N2 number of users associated with those highest ranked short-term preference values are sent product information from that product category. Also, for each product category, the associated current preference values are ranked from the greatest to the lowest in magnitude and the top N3 number of users associated with those highest ranked current preference values are sent product information from that product category.

In some other embodiments, for each product category, a combination of the long-term preference, short-term preference, and current preference values is a basis upon a certain quantity of product information that is sent to each user associated with the long-term preference, short-term preference, and current preference values. For example, for a user, it is determined which associated product categories are associated with which, if any, long-term preference, short-term preference, and current preference values. Then, for a product category, a subset of the users that are only associated with one of a long-term preference, short-term preference, and current preference value is sent a first quantity of product information associated with that product category. For a product category, a subset of the users that are only associated with two of a long-term preference, short-term preference, and current preference value is sent a second quantity of product information associated with that product category. And for a product category, a subset of the users that are associated with all three of a long-term preference, short-term preference, and current preference value is sent a third quantity of product information associated with that product category.

In some embodiments, a user's recent level of activity with respect to the e-commerce website is a basis upon a certain quantity of product information that is sent to each user. For example, a user's level of activity can be based upon the frequency that the user performs a user action with respect to the e-commerce website within a specified period of time. A threshold can be set such that if the user's level of activity meets or exceeds the threshold, then product information can be sent to the user associated with those product categories for which the user has associated short-term preference and current preference values. However, if the user's level of activity does not meet or exceed the threshold, then product information can be sent to the user associated with those product categories for which the user has associated long-term preference and current preference values.

In some embodiments, a user's status as a commercial user (e.g., a user that is associated with a business entity) is a basis upon a certain quantity of product information that is sent to each user. For example, if it is determined that a user is associated with a commercial status (as opposed to not being associated with a commercial status or being associated with a non-commercial status), then product information can be sent to the user associated with those product categories for which the user has associated long-term preference and current preference values. But if it is determined that a user is not associated with a commercial status or is associated with a non-commercial status, then product information can be sent to the user associated with those product categories for which the user has associated short-term preference and current preference values.

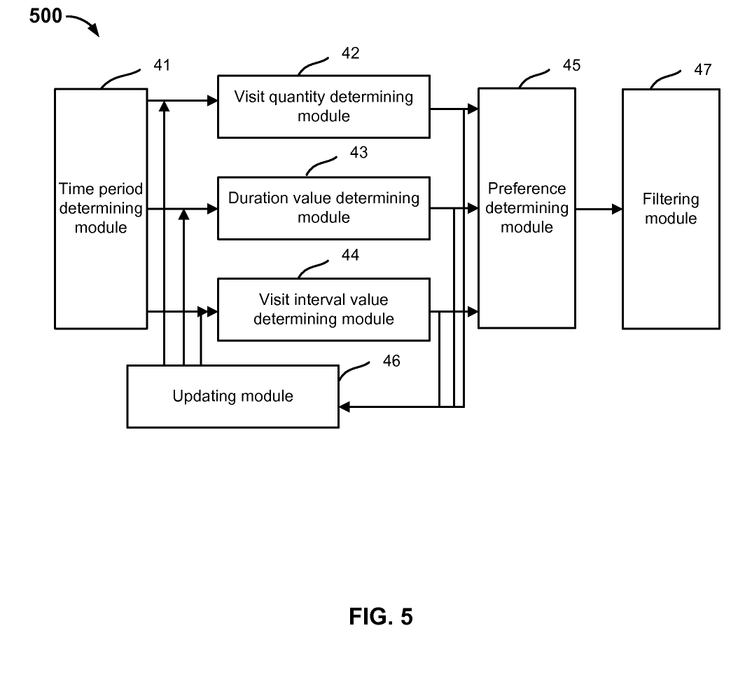

FIG. 5 is a diagram showing an embodiment of a system for determining preference values.

The modules can be implemented as software components executing on one or more processors, as hardware such as programmable logic devices and/or Application Specific Integrated Circuits designed to perform certain functions, or a combination thereof. In some embodiments, the modules can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The modules may be implemented on a single device or distributed across multiple devices.

Time period determining module 41 is configured to determine a current information collection period based on the date of the previous information collection and the date of the current information collection.

Visit quantity determining module 42 is configured to determine, for each user that performs a user action associated with a product category, the new visit quantity of the user during the current information collection period and to determine, based on the new visit quantity and the user's stored cumulative visit quantity for the product category, an updated cumulative visit quantity for the product category for this user.

Duration value determining module 43 is configured to determine a total duration value associated with a product category for the user based at least in part on a stored duration value associated with one or more previous information collection periods and a duration value associated with the current information collection period.

Visit interval value determining module 44 is configured to determine a visit interval value associated with the product category for the user and the current information collection period.

Preference determining module 45 is configured to determine the user's long-term preference value for the product category based at least in part on the updated cumulative visit quantity, the total duration value, and the visit interval value.

In some embodiments, preference determining module 45 is further configured to include: updating module 46 that is configured to store the updated cumulative visit quantity as the stored cumulative visit quantity and to store the total duration value as the stored duration value in preparation for the subsequent information collection period.

Filtering module 47 is configured to select product information to send to users based on the one or more preference values determined for various product categories.

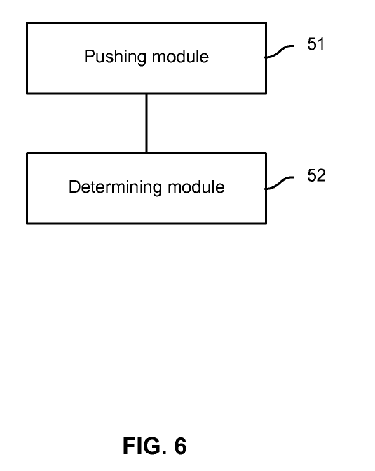

FIG. 6 is a diagram showing an embodiment of a system for sending product information to users based on associated preference values.

Determining module 52 is configured to determine the one or more preference values that are saved for each user.

Pushing module 51 is configured to send product information to a user based on that user's preference values associated with one or more product categories.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for determining a long-term preference value associated with a user for a product category, comprising:
determining pieces of user action data that are associated with a current information collection period, the user, and the product category;
determining a new visit quantity associated with the current information collection period based at least in part on a number of occurrences associated with each of one or more types of user action data included in the determined pieces of user action data;
determining an updated cumulative visit quantity associated with the product category based at least in part on the new visit quantity associated with the current information collection period and a stored cumulative visit quantity associated with the product category;
determining a total duration value associated with the product category based at least in part on a stored duration value associated with one or more previous information collection periods and a duration value associated with the current information collection period;
determining a visit interval value associated with the product category and the current information collection period; and
determining a long-term preference value associated with the user for the product category based at least in part on the updated cumulative visit quantity, the total duration value, and the visit interval value, wherein the long-term preference value indicates the user's interest in the product category over one or more information collection periods.

2. The method of claim 1, further comprising transmitting product information associated with the product category to the user based at least in part on the determined long-term preference value.

3. The method of claim 2, wherein the long-term preference value associated with the user for the product category determines one or more of the following: a manner in which the product information is sent to the user, a type of product information that is sent to the user, and a quantity of product information that is sent to the user.

4. The method of claim 1, further comprising:
storing the determined updated cumulative visit quantity as a stored cumulative visit quantity for a subsequent information collection period;
storing the determined total duration value as a stored duration value for the subsequent information collection period;
storing the determined visit interval value as a stored interval value for the subsequent information collection period; and
deleting the determined pieces of user action data for the current information collection period from storage.

5. The method of claim 1, further comprising determining a short-term preference value associated with the user for the product category.

6. The method of claim 1, further comprising determining a current preference value associated with the user for the product category.

7. The method of claim 1, wherein the current information collection period is defined by a date associated with a previous information collection and a date associated with a current information collection.

8. The method of claim 1, wherein the updated cumulative visit quantity comprises a sum of the stored cumulative visit quantity and the new visit quantity.

9. The method of claim 1, wherein the total duration value comprises a sum of the stored duration value and the duration value associated with the current information collection period.

10. The method of claim 1, wherein the visit interval value is determined based at least in part on a stored visit interval value.

11. The method of claim 1, wherein the long-term preference value associated with the user for the product category is determined as a product of the updated cumulative visit quantity and the total duration value divided by the visit interval value.

12. The method of claim 1, further comprising determining whether the user is associated with a one or both of a first status and a second status; in the event that the user is associated with the first status, transmitting product information associated with the product category to the user based at least in part on the long-term preference value; and in the event that the user is associated with the second status, transmitting product information associated with the product category to the user based at least in part on a short-term preference value associated with the user for the product category.

13. A system for determining a long-term preference value associated with a user for a product category, comprising:
one or more processors configured to:
determine pieces of user action data that are associated with a current information collection period, the user, and the product category;
determine a new visit quantity associated with the current information collection period based at least in part on a number of occurrences associated with each of one or more types of user action data included in the determined pieces of user action data;
determine an updated cumulative visit quantity associated with the product category based at least in part on the new visit quantity associated with the current information collection period and a stored cumulative visit quantity associated with the product category;
determine a total duration value associated with the product category based at least in part on a stored duration value associated with one or more previous information collection periods and a duration value associated with the current information collection period;
determine a visit interval value associated with the product category and the current information collection period; and
determine a long-term preference value associated with the user for the product category based at least in part on the updated cumulative visit quantity, the total duration value, and the visit interval value, wherein the long-term preference value indicates the user's interest in the product category over one or more information collection periods; and
a memory coupled to the one or more processors and configured to provide the one or more processors with instructions.

14. The system of claim 13, wherein the one or more processors are further configured to transmit product information associated with the product category to the user based at least in part on the determined long-term preference value.

15. The system of claim 14, wherein the long-term preference value associated with the user for the product category determines one or more of the following: a manner in which the product information is sent to the user, a type of product information that is sent to the user, and a quantity of product information that is sent to the user.

16. The system of claim 13, wherein the one or more processors are further configured to:
store the determined updated cumulative visit quantity as a stored cumulative visit quantity for a subsequent information collection period;
store the determined total duration value as a stored duration value for the subsequent information collection period;
store the determined visit interval value as a stored interval value for the subsequent information collection period; and
delete the determined pieces of user action data for the current information collection period from storage.

17. The system of claim 13, wherein the current information collection period is defined by a date associated with a previous information collection and a date associated with a current information collection.

18. The system of claim 13, wherein the long-term preference value associated with the user for the product category is determined as a product of the updated cumulative visit quantity and the total duration value divided by the visit interval value.

19. A computer program product for determining a long-term preference value associated with a user for a product category, the computer program product being embodied in a non-transitory computer readable medium and comprising computer instructions for:
determining pieces of user action data that are associated with a current information collection period, the user, and the product category;
determining a new visit quantity associated with the current information collection period based at least in part on a number of occurrences associated with each of one or more types of user action data included in the determined pieces of user action data;
determining an updated cumulative visit quantity associated with the product category based at least in part on the new visit quantity associated with the current information collection period and a stored cumulative visit quantity associated with the product category;
determining a total duration value associated with the product category based at least in part on a stored duration value associated with one or more previous information collection periods and a duration value associated with the current information collection period;
determining a visit interval value associated with the product category and the current information collection period; and
determining a long-term preference value associated with the user for the product category based at least in part on the updated cumulative visit quantity, the total duration value, and the visit interval value, wherein the long-term preference value indicates the user's interest in the product category over one or more information collection periods.
